(19) United States
(12) Patent Application Publication
(10) Pub. No.: US 2024/0372480 A1
(43) Pub. Date: Nov. 7, 2024

(54) MULTI-SYNCHRONOUS RECTIFIER (SR) DRIVE SWITCHING CONTROL SYSTEM

(71) Applicant: TEXAS INSTRUMENTS INCORPORATED, DALLAS, TX (US)

(72) Inventor: ISAAC COHEN, DIX HILLS, NY (US)

(21) Appl. No.: 18/492,385

(22) Filed: Oct. 23, 2023

Related U.S. Application Data
(60) Provisional application No. 63/464,364, filed on May 5, 2023.

(51) Int. Cl. H02M 3/335; H02M 1/00

(52) U.S. Cl. CPC H02M 3/33592; H02M 1/0009

(57) ABSTRACT

In a described example, a switching controller can be configured to activate a first rectifier switch of an output stage of a power supply system in a first state to provide a secondary current from a secondary winding of a first transformer to generate an output voltage at the output stage in response to detecting a first direction of a secondary current through a secondary winding of a second transformer. Additionally, the switching controller can be configured to activate a second rectifier switch of the output stage of the power supply system in a second state to provide the secondary current from the secondary winding of the first transformer to generate the output voltage at the output stage in response to detecting a second direction of the secondary current through the secondary winding of the second transformer.

### RELATED APPLICATIONS

This application claims priority from U.S. Patent Application Ser. No. 63/464,364, filed 5 May 2023, which is incorporated herein in its entirety.

### TECHNICAL FIELD

This description relates to systems and methods for controlling switches of a switching stage of a power supply system to be operated as a synchronous rectifier (SR).

### BACKGROUND

Power converters are becoming increasingly commonplace in the electrical industry. Product manufacturers and suppliers of electrical equipment are demanding ever-increasing functionality (i.e., lower input and output voltages, higher currents, faster transient response) from their power supply systems. In high voltage bidirectional converter applications, switches can operate both as rectifiers and as active switches. For example, a body diode drop of high voltage metal-oxide-semiconductor field-effect transistors (MOSFETs) can be relatively high (e.g., 3V), resulting in excessive conduction power dissipation if the FET is operated as a rectifier. Therefore, it is desirable that the switches be operated as a synchronous rectifier (SR) for rectification purposes. However, it is a challenge to combine control for synchronous rectification and active switching functions. Generating the signal for the synchronous rectification drive is particularly challenging because of the high drain voltage of the FETs.

### SUMMARY

In a described example, a switching controller can be configured to activate a first rectifier switch of an output stage in a first state to provide a secondary current from a secondary winding of a first transformer to generate an output voltage at the output stage in response to detecting a first direction of a secondary current through a secondary winding of a second transformer. Additionally, the switching controller can be configured to activate a second rectifier switch of the output stage in a second state to provide the secondary current from the secondary winding of the first transformer to generate the output voltage at the output stage in response to detecting a second direction of the secondary current through the secondary winding of the second transformer.

In a described example, a circuit can include a resistor, a first direction detection comparator, a second direction detection comparator, a first set of logic, and a second set of logic. The resistor can include a terminal coupled to a first current direction detection terminal. The first direction detection comparator can include a first input, a second input, and an output. The first input of the first direction detection comparator is coupled to the first current direction detection terminal and the second input of the first direction detection comparator is coupled to a first reference voltage. The second direction detection comparator can include a first input, a second input, and an output. The first input of the second direction detection comparator is coupled to a second current direction detection terminal and the second input of the second direction detection comparator is coupled to a second reference voltage. The first set of logic can include an input and an output. The input of the first set of logic is coupled to the output of the first direction detection comparator and the output of the first set of logic is coupled to an input of a first rectifier switch. The second set of logic can include an input and an output. The input of the second set of logic is coupled to the output of the second direction detection comparator and the output of the second set of logic is coupled to an input of a second rectifier switch.

In a described example, a power supply system can include a first switching stage and a second switching stage. The first switching stage can be configured to conduct a primary current in a first direction through a primary winding of a first transformer in a first state and in a second direction through the primary winding opposite the first direction in a second state to provide a secondary current in a first direction through a secondary winding of the first transformer in the first state and in a second direction through the secondary winding in the second state based on the primary current. The second switching stage can be configured to provide an output voltage at a second switching stage in response to the secondary current. The second switching stage can include a switching controller. The switching controller can be configured to activate a first rectifier switch of the second switching stage in a first state. The first rectifier switch can be configured to provide a secondary current from the secondary winding of the first transformer to generate an output voltage at the second switching stage in response to the switching controller detecting a first direction of a secondary current through a secondary winding of a second transformer. Additionally, the switching controller can be configured to activate a second rectifier switch of the second switching stage in a second state. The second rectifier switch can be configured to provide the secondary current from the secondary winding of the first transformer to generate the output voltage at the second switching stage in response to the switching controller detecting a second direction of the secondary current through the secondary winding of the second transformer.

### BRIEF DESCRIPTION OF THE DRAWINGS

FIG. 1 is a block diagram of an example of a power supply system.

FIG. 2 is a schematic diagram of an example of a power supply circuit.

FIG. 3 is a timing diagram of waveforms associated with the power supply system, in an example.

FIG. 4 is a schematic diagram of a power supply circuit, in an example.

FIG. 5 is a diagram of an example of a power supply system integrated circuit (IC).

### DETAILED DESCRIPTION

This description relates generally to electronic circuits, and more particularly to a power supply system. The power supply system can include a power transformer (e.g., a first transformer) to inductively transfer a voltage from a primary winding to a secondary winding to generate an output voltage based on a provided input voltage.

The power supply system includes a first switching stage that includes a set of switches that are activated to provide a primary current to the primary winding of the power transformer. A secondary current is generated in the secondary winding of the power transformer based on this input voltage. As an example, the first switching stage can be configured as one of a half-bridge switching circuit, a full-bridge switching circuit, a push-switching circuit, or any of a variety of other types of switching circuits.

The power supply system also includes a second switching stage (e.g., an output stage) that is configured to provide an output voltage based on the secondary current. As described herein, the phrase “configured to” with respect to the functionality of the elements of the power supply system refers to any of a number of ways of enabling a function of the elements of the power supply system, such as based on fabrication, assembly of discrete elements for interrelated function, and/or programming by a controller. The second switching stage can be configured to rectify the secondary current to provide a positive amplitude of the output voltage at each of opposite polarities of the secondary current.

The second switching stage includes rectifier switches to rectify the secondary current. The rectifier switches can be arranged in a bridge configuration and can operate both as rectifiers and as active switches. Each rectifier switch can be implemented similarly to an ideal diode emulator and include a switch and a body diode. Because the voltage drop across a rectifier device can be as high as several volts in high-voltage applications, conduction through a rectifier diode can result a higher than desired power dissipation. Therefore, the rectifier switches can be operated as a synchronous rectifier (SR) for rectification purposes. By operating the rectifier switches as SRs, when the rectifier switches conduct current, the current flows through the channel of the rectifier switches rather than through the body diode, thereby resulting in a lower voltage drop across the rectifier switches.

The second switching stage can include a direction detection transformer. The direction detection transformer can be configured to sense a direction of the secondary current in the second switching stage. The second switching stage can further include a switching controller. The switching controller includes one or more direction detection resistors that can provide a direction voltage based on the sensed direction of the secondary current. The switching controller can operate by comparing the direction voltage(s) from the one or more direction detection resistors with a reference voltage to determine the direction of the secondary current from the second switching stage. The switching controller can include logic which is configured to control the rectifier switches to provide rectification of the secondary current to generate the output voltage. Additionally, the switching controller can enable reverse operation of the power supply system based on an enable signal and reverse switching signals for individual rectifier switches. For example, in reverse operation, a reverse primary current is provided from the output voltage of the power supply system through the secondary winding of the power transformer to generate a reverse secondary current in the primary winding of the power transformer. In this way, the flow of power through the power supply system can be reversed, enabling the power supply system to operate as a bi-directional converter. For example, energy can be extracted from a battery connected to an output of the second switching stage and delivered back into the input source (e.g., the first switching stage).

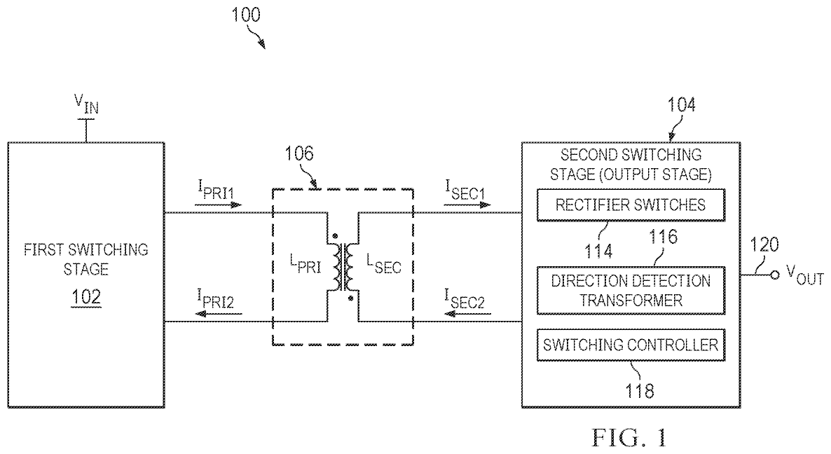

FIG. 1 is a block diagram of an example of a power supply system 100. The power supply system 100 can be implemented in any of a variety of circuit applications for efficiently providing an output voltage V_{OUT} at an output 120 based on an input voltage V_{IN}. The power supply system 100 includes a first switching stage 102, a second switching stage (e.g., an output stage) 104, and a power transformer (e.g., first transformer) 106. The first switching stage 102 includes at least one switch that is periodically activated in response to a switching signal. As an example, the first switching stage 102 can be arranged as a full-bridge circuit, a half-bridge circuit, a push-pull circuit, or any of a variety of other switching circuits. The power transformer 106 includes a primary winding L_{PRI} and a secondary winding L_{SEC}. The switches of the first switching stage 102 can be activated to provide the input voltage V_{IN} to the primary winding L_{PRI}, which in turn, provides a primary current I_{PRI1} in a first direction through the primary winding L_{PRI} or a primary current I_{PRI2} in a second direction through the primary winding L_{PRI} of the power transformer 106.

In the example of FIG. 1, the primary current I_{PRI} can reverse direction in each switching cycle of the switches in the first switching stage 102. The power transformer 106 can therefore induce a secondary current I_{SEC1} in a first direction through the secondary winding L_{SEC} in response to the primary current I_{PRI1} being provided through the primary winding L_{PRI} in the first direction. Additionally, the power transformer 106 can induce a secondary current I_{SEC2} in a second direction through the secondary winding L_{SEC} in response to the primary current I_{PRI2} being provided through the primary winding L_{PRI} in the second direction.

The second switching stage 104 can provide the output voltage V_{OUT} based on the secondary current I_{SEC1} and the secondary current I_{SEC2}. The secondary current I_{SEC} can reverse direction in each of the switching cycles of the switching frequency in response to the primary current I_{PRI} reversing direction. The second switching stage 104 can be configured to rectify the secondary current I_{SEC} to provide a positive amplitude of the output voltage V_{OUT} during each of the directions of the secondary current I_{SEC}, as inductively provided from the respective directions of the primary current I_{PRI}. As an example, other arrangements of the second switching stage 104 are possible (e.g., as a voltage doubler).

Further, the second switching stage 104 can include rectifier switches 114, a direction detection transformer 116, and a switching controller 118. The rectifier switches 114 can be arranged in a bridge configuration and can operate both as rectifiers and as active switches. For example, the rectifier switches 114 can be operated as a synchronous rectifier (SR) for rectification purposes. According to one example, each rectifier switch can be implemented as an ideal diode emulator including a switch, such as a MOSFET (e.g., an N-channel FET (N-FET)), and a body diode.

The direction detection transformer 116 can be configured to sense a direction of the secondary current I_{SEC} from the second switching stage 104. Based on the sensed direction of the secondary current I_{SEC}, a control signal for synchronous rectification drive and active switching functions can be generated by the switching controller 118. The switching controller 118 includes one or more direction detection resistors that can provide a direction voltage based on the direction of the secondary current I_{SEC}. The switching controller 118 can operate by comparing the direction voltage from one or more direction detection resistors with a first reference voltage V_{REF} to determine the direction of the secondary current I_{SEC} in the second switching stage 104.

The switching controller 118 can include logic which can be configured to control the rectifier switches 114 to rectify the secondary current I_{SEC}, or to enable reverse operation of the power supply system 100 based on an enable signal and reverse switching signals for individual rectifier switches 114. For example, in reverse operation, a reverse primary current is provided from the output voltage V_{OUT} of the power supply system 100 through the secondary winding L_{SEC} of the power transformer 106 to generate a reverse secondary current in the primary winding L_{PRI} of the power transformer 106 to charge a power supply associated with the input voltage V_{IN}.

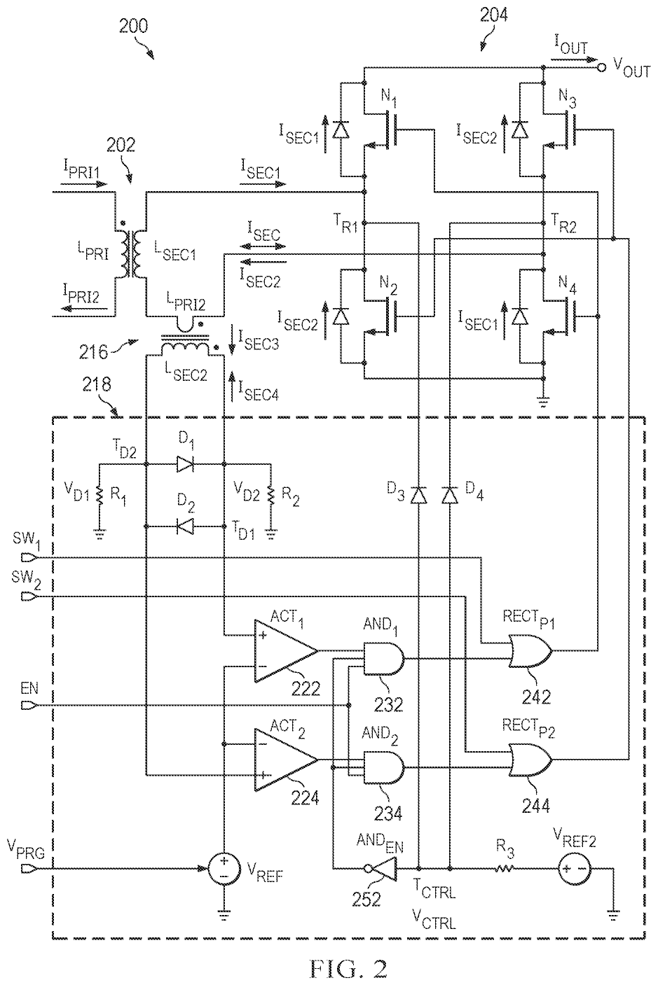

FIG. 2 is a schematic diagram of an example of a power supply circuit 200. The power supply circuit 200 includes a power transformer 202 (e.g., a first transformer) that includes a primary winding L_{PRI1} and a secondary winding L_{SEC1}. The power transformer 202 can be configured to conduct a primary current I_{PRI} (e.g., provided by the first switching stage 102) in a first direction through the primary winding L_{PRI1} of the power transformer 202 in a first state and in a second direction through the primary winding L_{PRI1} opposite the first direction in a second state to provide a secondary current I_{SEC1} in a first direction through the secondary winding L_{SEC1} of the power transformer 202 in the first state and in the second direction through the secondary winding L_{SEC1} in the second state based on the primary current I_{PRI}. Thus, the primary winding L_{PRI1} is configured to conduct the primary current I_{PRI} from the input voltage V_{IN} to generate the secondary current I_{SEC} at the second switching stage 204 via the secondary winding L_{SEC1}.

As discussed above, and similarly in the example of FIG. 1, the second switching stage 204 includes rectifier switches (demonstrated as N-FETs N₁, N₂, N₃, and N₄), a direction detection transformer 216, a switching controller 218. For example, the power transformer 202, the second stage 204, the rectifier switches N₁, N₂, N₃, and N₄, the direction detection transformer 216, and the switching controller 218 can correspond to the power transformer 106, the second stage 104, the rectifier switches 114, the direction detection transformer 116, and the switching controller 118, respectively, of the example of FIG. 1.

The switching controller 218 controls driving of the gates of the rectifier switches N₁, N₂, N₃, and N₄ based on the direction of the secondary current I_{SEC} of the power transformer 202 or the body diodes of the rectifier switches N₁, N₂, N₃, and N₄ being forward-biased, for example.

The rectifier switches N₁, N₂, N₃, N₄ can be arranged in a bridge configuration and operate both as rectifiers and as active switches. Each of the rectifier switches N₁, N₂, N₃, and N₄ can be implemented similarly to an ideal diode emulator and includes a switch and a body diode. Because the voltage drop across the rectifier switches N₁, N₂, N₃, and N₄ can be as high as several volts in high-voltages applications, this can result a higher than desired power dissipation. Due to this voltage drop, the rectifier switches N₁, N₂, N₃, and N₄ can be operated as a synchronous rectifier (SR) for rectification purposes. By operating the rectifier switches N₁, N₂, N₃, and N₄ as SRs, when the rectifier switches N₁, N₂, N₃, and N₄ conduct current, the secondary current I_{SEC} flows to the channel of the switches rather than to the body diode of the respective rectifier switch, thereby resulting a low voltage drop across the rectifier switches.

The second switching stage (e.g., output stage) 204 can be configured (e.g., by a controller) to provide the output voltage V_{OUT} at the output 120 in response to the secondary current I_{SEC}. The second switching stage can include the switching controller 218. The switching controller 218 can be configured to activate a first pair of rectifier switches (e.g., switches N₁ and N₄) of the second switching stage 204 in the first state (e.g., associated with detecting the first direction of the secondary current I_{SEC}). To clarify, the first pair of rectifier switches N₁ and N₄ of FIG. 2 corresponds to the first rectifier switch described above in the example of FIG. 1. The first and second pairs of rectifier switches can be configured to provide the secondary current I_{SEC} from the secondary winding L_{SEC1} of the power transformer 202 to generate the output voltage V_{OUT} at the second switching stage 204 in response to the switching controller 218 detecting the first direction of a secondary current L_{SEC1} through a secondary winding L_{SEC2} of the direction detection transformer 216 (e.g., a second transformer).

Additionally, the switching controller 218 can be configured to activate a second pair of rectifier switches (e.g., switches N₂ and N₃) of the second switching stage 204 in the second state (e.g., associated with detecting the second direction of the secondary current I_{SEC}). To clarify, the second pair of rectifier switches N₂ and N₃ of FIG. 2 corresponds to the second rectifier switch described above in the example of FIG. 1. The second pair of rectifier switches N₂ and N₃ can be configured to provide the secondary current I_{SEC} from the secondary winding L_{SEC1} of the power transformer 202 to generate the output voltage V_{OUT} at the second switching stage 204 in response to the switching controller 218 detecting the second direction of the secondary current through the secondary winding L_{SEC2} of the direction detection transformer 216.

In the first state, the rectifier switches N₁ and N₄ are concurrently activated to conduct the secondary current I_{SEC1} to the output. In the example of FIG. 2, the secondary current I_{SEC1} is provided from a low-voltage rail (e.g., ground), through the rectifier switch N₄ to the second rectifier terminal T_{R2}, through the rectifier switch N₁, and to the output of the power supply circuit 200 as an output current I_{OUT} to generate the output voltage V_{OUT}. For example, the output current I_{OUT} can be provided through an output inductor (not shown) across an output capacitor (not shown). In the second state, the rectifier switches N₂ and N₃ are concurrently activated to conduct the secondary current I_{SEC2} to the output. In the example of FIG. 2, the secondary current I_{SEC2} is provided from the low-voltage rail, through the rectifier switch N₂ to the first rectifier terminal T_{R1}, through the rectifier switch N₃, and to the output of the power supply circuit 200 as the output current I_{OUT} to generate the output voltage V_{OUT}.

In the example of FIG. 2, the switching controller 218 includes a first direction detection resistor R₁ interconnecting a first direction detection terminal T_{D1} and the low-voltage rail (e.g., ground), and a second direction detection resistor R₂ interconnecting a second direction detection terminal T_{D2} and the low-voltage rail. Additionally, the switching controller 218 can include clamping diodes (e.g., a first clamping diode D₁, a second clamping diode D₂) which are configured to clamp respective first and second direction voltages V_{D1}, V_{D2} of the first and second direction detection resistor R₁, R₂ to a predefined amplitude.

The direction detection transformer 216 and direction detection resistors R₁, R₂ can be configured to sense a direction of the secondary current I_{SEC} from the second switching stage 204. A primary winding L_{PRI2} of the direction detection transformer 216 can be coupled in series with the secondary winding L_{SEC1} of the power transformer 202 and the secondary winding L_{SEC2} of the direction detection transformer 216 can be interconnected with the first direction detection terminal T_{D1} and the second direction detection terminal T_{D2}. A turns ratio of the direction detection transformer 216 can be greater than 50:1. For example, the direction detection transformer 216 is configured to detect the direction (e.g., polarity) of the secondary current I_{SEC} in the secondary winding L_{SEC1}, and not for the transfer of energy. Therefore, the turns ratio being selected to be greater than 50:1, for example, enables the voltage to be stepped down to a more manageable voltage at a direction detection resistor.

Based on the arrangement of the direction detection transformer 216 being in series with the secondary winding L_{SEC1}, secondary current flows to one of the first or second direction detection resistors R₁, R₂, thereby generating a voltage (e.g., the first direction voltage V_{D1} and the second direction voltage V_{D2}) across one of the respective first or second direction detection resistors R₁, R₂ relative to a low voltage rail (e.g., ground).

According to one example, the power supply system 100 can be implemented with two direction detection resistors R₁, R₂. The first direction detection resistor R₁ can be configured to generate a first direction voltage V_{D1} in response to a first direction of the secondary current I_{SEC1} from the second switching stage 204. For example, the secondary current I_{SEC} at the second switching stage 204 of the power transformer 202 acts as a primary current in the first direction through the primary winding L_{PRI2} of the direction detection transformer 216 (e.g., a second transformer) in the first state and in the second direction through the primary winding L_{PRI2} opposite the first direction in the second state to provide a direction detection secondary current in the first direction I_{SEC3} through the secondary winding L_{SEC2} in the first state based on the secondary current I_{SEC} from the second switching stage 204 of the power transformer 202. The resulting direction detection secondary current I_{SEC3} can thus cause the first direction detection resistor R₁ to generate the first direction voltage V_{D1}. Therefore, the first direction voltage V_{D1} is associated with the first direction of the secondary current in the secondary winding L_{SEC2}.

The second direction detection resistor R₂ can be configured to generate the second direction voltage V_{D2} in response to a second direction of the secondary current I_{SEC2} from the second switching stage 204. For example, the secondary current I_{SEC} from the second switching stage 204 of the power transformer 202 acts as the primary current in the second direction through the primary winding L_{PRI2} in the first state and in the second direction through the primary winding L_{PRI2} opposite the first direction in the second state to provide the direction detection secondary current in the second direction I_{SEC4} through the secondary winding in the second state based on the secondary current I_{SEC} from the second switching stage 204 of the power transformer 202. The resulting direction detection secondary current I_{SEC4} can thus cause the second direction detection resistor R₂ to generate the second direction voltage V_{D2}. Therefore, the second direction voltage V_{D2} is associated with the second direction of the secondary current in the secondary winding L_{SEC2}.

The resistance of the first and second direction detection resistors R₁, R₂ can be approximately equal. The secondary winding L_{SEC2} can interconnect each of the first direction detection terminal T_{D1} and the second direction detection terminal T_{D2} that are each inputs of the switching controller 218 to indicate one of the first direction and the second direction of the secondary current I_{SEC}.

The implementation of the first clamping diode D₁ and the second clamping diode D₂ clamping diodes enables the direction detection transformer 216 to be smaller in scale, as the direction detection transformer 216 is configured to detect the direction (e.g., polarity) of the secondary current I_{SEC} in the secondary winding L_{SEC1}, and not for the transfer of energy. Stated another way, the clamping diodes mitigate the volt-second requirement of the direction detection transformer 216.

The switching controller 218 can include a reference voltage generator V_{REF} configured to generate the first reference voltage V_{REF} as a programmable variable reference voltage. In response to deactivation of a given pair of the rectifier switches N₁, N₂, N₃, and N₄, parasitic capacitances associated with components of the switching controller 218, such as the rectifier switches N₁, N₂, N₃, and N₄, can combine with the secondary winding L_{SEC1} to form a resonator that can cause ringing in the secondary current I_{SEC}. The ringing in the secondary current I_{SEC} can be sensed by the switching controller 218, resulting in undesirable, spurious activation of the rectifier switches N₁, N₂, N₃, and N₄. To prevent such spurious activation of the rectifier switches N₁, N₂, N₃, and N₄, the first reference voltage V_{REF} can have an amplitude greater than an amplitude of the direction detection voltages generated by the ringing of the secondary current I_{SEC}. In the example of FIG. 2, the reference voltage generator V_{REF} can be programmable, such as by a programming voltage signal V_{PRG}, based on the amplitude of the ringing of the secondary current I_{SEC} to enable the first and second direction detection comparators 222, 224 to effectively ignore the ringing of the secondary current I_{SEC} during operation. Additionally, the reference voltage generator V_{REF} can be programmed by a control circuit to adjust the value of any reference voltages described herein (e.g., V_{REF}) based on operating conditions, for example.

The switching controller 218 can be configured to activate the first pair of rectifier switches N₁ and N₄ in the first state to provide the secondary current I_{SEC} from the secondary winding L_{SEC1} to generate the output voltage V_{OUT} at the second switching stage 204 in response to detecting the first direction of the secondary current through the secondary winding L_{SEC2}. The switching controller 218 can be configured to activate the second pair of rectifier switches N₂ and N₃ of the second switching stage 204 in the second state to provide the secondary current I_{SEC} from the secondary winding L_{SEC1} to generate the output voltage V_{OUT} at the second switching stage 204 in response to detecting the second direction of the secondary current through the secondary winding L_{SEC2}. The switching controller 218 can include a first direction detection comparator 222 and a second direction detection comparator 224.

In this regard, the first direction detection comparator 222 and the second direction detection comparator 224 are configured to compare the direction voltages V_{D1}, V_{D2} to the first reference voltage V_{REF} to determine the direction of the secondary current I_{SEC} at the secondary winding L_{SEC1}. The first direction voltage V_{D1} is a positive voltage greater than the first reference voltage V_{REF}, causing an output of the first direction detection comparator 222, which is a first activation signal ACT₁, to be logic-high. The logic-high of the first activation signal ACT₁ can thus supply a drive to close the first pair of rectifier switches N₁ and N₄ of the rectifier bridge, allowing the secondary current I_{SEC1} to flow for that diagonal of the bridge, and mitigating or lowering the voltage drop at the respective rectifier switches N₁, N₂, N₃, and N₄ to be well below the voltage drop of the corresponding body diodes for N₁ and N₄. When the secondary current I_{SEC2} at the secondary winding L_{SEC1} flows in the opposite or second direction, the first direction voltage V_{D1} will drop below the first reference voltage V_{REF}, causing the first activation signal ACT₁ to be logic-low, thereby opening switches of the corresponding gates for N₁ and N₄.

Conversely, when the secondary current at the secondary winding L_{SEC1} flows in the second direction, secondary current is induced at the secondary winding L_{SEC2} in the second direction, generating the second direction voltage V_{D2} across the second direction detection resistor R₂. The second direction voltage V_{D2} is a positive voltage relative to the low voltage rail, causing an output of the second direction detection comparator 224, which is a second activation signal ACT₂, to be logic-high. The logic-high of the second activation signal ACT₂ can thus supply a drive to corresponding gates of opposite diagonals (e.g., a second pair including N₂ and N₃) of the rectifier bridge, thereby closing switches of the corresponding opposite diagonal gates, allowing current I_{SEC2} to flow for that diagonal of the bridge, and mitigating or lowering the voltage drop at the respective rectifier switches N₁, N₂, N₃, and N₄ to be well below the voltage drop of the corresponding body diodes for N₂ and N₃. When the secondary current I_{SEC1} at the secondary winding L_{SEC1} flows in the opposite or first direction, the second direction voltage V_{D2} will drop below the first reference voltage V_{REF}, causing the second activation signal ACT₁ to be logic-low, thereby opening switches of the opposite corresponding gates for N₂ and N₃.

In this way, the first direction detection comparator 222 is configured to generate the first activation signal ACT₁ (which is provided as a logic-high to activate the first pair of rectifier switches N₁ and N₄) in response to the first direction voltage V_{D1} at the first direction detection terminal T_{D1} being greater than the reference voltage V_{REF}. As discussed above, the first direction voltage V_{D1} is associated with the first direction of the secondary current of the direction detection transformer 216. In the example of FIG. 2, the first direction detection comparator 222 includes a first input, a second input, and an output. The first input of the first direction detection comparator 222 is coupled to the first direction detection terminal T_{D1} and the second input of the first direction detection comparator 222 is coupled to the first reference voltage V_{REF}, thereby enabling the first direction detection comparator 222 to compare the first direction voltage V_{D1} with the first reference voltage V_{REF}.

The second direction detection comparator 224 is configured to generate the second activation signal ACT₂ (which is provided as a logic-high to activate the second pair of rectifier switches N₂ and N₃) in response to the second direction voltage V_{D2} at the second direction detection terminal T_{D2} being greater than a reference voltage (e.g., the first reference voltage V_{REF}). As discussed above, the second direction voltage V_{D2} is associated with the second direction of the secondary current. In the example of FIG. 2, the second direction detection comparator 224 can include a first input, a second input, and an output. The first input of the second direction detection comparator 224 is coupled to the second direction detection terminal T_{D2} and the second input of the second direction detection comparator 224 is coupled to the first reference voltage V_{REF}, thereby enabling the second direction detection comparator 224 to compare the second direction voltage V_{D2} with the first reference voltage V_{REF}.

The switching controller 218 can include a first set of logic that includes a first mode control AND gate 232 and a second set of logic that includes a second mode control AND gate 234. The first mode control AND gate 232 is configured to receive the first activation signal ACT1 at a first input, and the second mode control AND gate 234 is configured to receive the second activation signal ACT2 at a first input.

The switching controller 218 can include rectifier diodes D₃, D₄. Each of the first and second rectifier diodes D₃, D₄ is coupled at an anode to the control terminal T_{CTRL} having a control voltage V_{CTRL}. Rectifier diodes D₃, D₄ are configured to activate corresponding rectifier switches N₁, N₂, N₃, and N₄ in response to being forward-biased based on the direction of the secondary current I_{SEC}. The rectifier diodes D₃ and D₄ allow activation of the rectifier switches N₁, N₂, N₃, and N₄ by enabling driving of the respective switches when the corresponding body diodes of the respective rectifier switches N₁ and N₄ or N₂ and N₃ are already conducting the respective secondary currents I_{SEC1} or I_{SEC2}, and when the drain-to-source voltages of the respective rectifier switches N₁ and N₄ or N₂ and N₃ is sufficiently low (e.g., approximately zero). Therefore, the rectifier prevents activation of the rectifier switches N₁, N₂, N₃, and N₄ if the drain-to-source voltages of the respective rectifier switches N₁ and N₄ or N₂ and N₃ is too high, which can result in high switching losses or even destruction of the rectifier switches N₁, N₂, N₃, and N₄.

With respect to FIG. 2, the body diodes of the rectifier switches N₁ and N₄ form the first pair of rectifier switches and the body diodes of the rectifier switches N₂ and N₃ form the second pair of rectifier switches. In the bridge configuration of FIG. 2, only one pair of the two pairs can conduct at a given moment. In response to a transition in the direction of the secondary current I_{SEC2} from the second direction to the first direction I_{SEC1}, the rectifier switches N₁ and N₄ are initially in a deactivated state. The initial small amplitude of the secondary current I_{SEC} thus conducts through the body diodes of the first pair of rectifier switches N₁ and N₄. Because the secondary current I_{SEC} is conducted from the low-voltage rail (e.g., ground), the initial conduction of the secondary current I_{SEC} can cause the voltage at the second rectifier terminal T_{R2} at the cathode of the second rectifier diode D₄ to be at a negative amplitude voltage that is sufficient to forward-bias the second rectifier diode D₄. Before the second rectifier diode D₄ is forward-biased, the control terminal T_{CTRL} has a voltage amplitude that is logic-high (e.g., approximately equal to V_{REF2}). However, the forward-bias of the second rectifier diode D₄ can pull the control voltage V_{CTRL} at the control terminal T_{CTRL} to a logic-low amplitude due to a voltage drop across the second rectifier diode D₄.

The switching controller 218 also includes an inverter 252 that provides a signal AND_{EN} to the first mode control AND gate 232 of the first set of logic. After the second rectifier diode D₄ is forward-biased, the inverter 252 provides the signal AND_{EN} to the AND gate 232 as logic-high, thereby providing the outputs AND₁ from the AND gate 232 to likewise be logic-high (assuming that a mode control signal EN and the first activation signal ACT₁ are also logic-high) to enable driving of the first pair of rectifier switches N₁ and N₄ to their activated state. Explained yet again, in response to the forward-bias of the second rectifier diode D₄ pulling the control terminal T_{CTRL} to a logic-low state, the inverter 252 provides a logic-high input to the AND gate 232, thereby activating the rectifier switches N₁ and N₄ to provide conduction of the secondary current I_{SEC1} through channels of the first pair of rectifier switches N₁ and N₄ instead of the respective body diodes of the first pair of rectifier switches N₁ and N₄. In this way, the rectifier diode D₄ prevents activation of the respective first pair of rectifier switches N₁ and N₄ when the drain-to-source voltages of the first pair of rectifier switches N₁ and N₄ are not sufficiently low (e.g., approaching or approximately zero volts).

Similarly, in response to a transition in the direction of the secondary current I_{SEC1} from the first direction to the second direction I_{SEC2}, the rectifier switches N₂ and N₃ are initially in a deactivated state. The initial small amplitude of the secondary current I_{SEC2} thus conducts through the body diodes of the second pair of rectifier switches N₂ and N₃. Because the secondary current I_{SEC2} is conducted from the low-voltage rail (e.g., ground), the initial conduction of the secondary current I_{SEC} can cause the voltage at the first rectifier terminal T_{R1} at the cathode of the first rectifier diode D₃ to be at the negative amplitude voltage that is sufficient to forward-bias the first rectifier diode D₃. Before the first rectifier diode D₃ is forward-biased, the control terminal T_{CTRL} has a voltage amplitude that is logic-high (e.g., approximately equal to V_{REF2}). However, the forward-bias of the first rectifier diode D₃ can pull the control voltage V_{CTRL} at the control terminal T_{CTRL} to the logic-low amplitude due to a voltage drop across the first rectifier diode D₃.

After the first rectifier diode D₃ is forward-biased, the inverter 252 provides the signal AND_{EN} to the AND gate 234 as logic-high, thereby providing the outputs AND₂ from the AND gate 234 to likewise be logic-high (assuming that the mode control signal EN and the second activation signal ACT₂ are also logic-high) to enable driving of the second pair of rectifier switches N₂ and N₃ to their activated state. Explained yet again, in response to the forward-bias of the first rectifier diode D₃ pulling the control terminal T_{CTRL} to a logic-low state, the inverter 252 provides a logic-high input to the AND gate 234, thereby activating the switches N₂ and N₃ to provide conduction of the secondary current I_{SEC2} through channels of the rectifier switches N₂ and N₃ instead of the respective body diodes of the rectifier switches N₂ and N₃. Similar to as described above, the rectifier diode D₃ prevents activation of the respective second pair of rectifier switches N₂ and N₃ when the drain-to-source voltages of the second pair of rectifier switches N₂ and N₃ are not sufficiently low (e.g., approaching or approximately zero volts).

The switching controller 218 can control synchronous rectification and active switching functions for the rectifier switches N₁, N₂, N₃, and N₄ based on input control signals, such as a mode control signal EN, a first reverse switching signal SW₁, and a second reverse switching signal SW₂.

The first input of the first mode control AND gate 232 is coupled to the first activation signal ACT₁. The second input of the first mode control AND gate 232 is coupled to receive the mode control signal EN. The third input of the first mode control AND gate 232 is coupled to receive the AND_{EN} signal from the inverter 252. Thus, the first mode control AND gate 232 requires the first activation signal ACT₁, the mode control signal EN, and the AND_{EN} signal to be logic-high to proceed with operation in a first power supply system operational state where the power supply system 100 operates to provide the output voltage V_{OUT} based on the secondary current from the secondary winding L_{SEC1}. The first set of logic can include a first OR gate 242 including a first input, a second input, and an output. The first input of the first OR gate 242 is coupled to the output of the first mode control AND gate 232, which is the AND₁ signal. The second input of the first OR gate 242 is coupled to receive the first reverse switching signal SW₁. The output of the first OR gate 242 is the output for the first set of logic and is a first rectifier control signal RECT_{P1} configured to bias gates of the first pair of rectifier switches N₁ and N₄. The input of the first set of logic is coupled to the first activation signal ACT₁, which is the output generated by the first direction detection comparator 222. The switching controller 218 can include a first rectifier diode D₃ having an anode coupled to a control terminal T_{CTRL} and a cathode coupled to a first rectifier terminal T_{R1}. The control terminal T_{CTRL} is coupled to a second reference voltage V_{REF2}. The second reference voltage V_{REF2} and a resistor R₃ can be configured to generate the control voltage V_{CTRL} as a programmable variable reference voltage.

The switching controller 218 can include a second set of logic including an input and an output. The second set of logic can include a second mode control AND gate 234 including a first input, a second input, and an output. The first input of the second mode control AND gate 234 is coupled to the second activation signal ACT₂. The second input of the second mode control AND gate 234 is coupled to receive the mode control signal EN. The third input of the second mode control AND gate 234 is coupled to receive the AND_{EN} signal from the inverter 252. Thus, the second mode control AND gate 234 requires the second activation signal ACT₁, the mode control signal EN, and the AND_{EN} signal to be logic-high to proceed with operation in the first power supply system operational state where the power supply system 100 operates to provide the output voltage V_{OUT} based on the secondary current from the secondary winding L_{SEC1}. The second set of logic can include a second OR gate 244 including a first input, a second input, and an output. The first input of the second OR gate 244 is coupled to the output of the second mode control AND gate 234, which is the AND₂ signal. The second input of the second OR gate 244 is coupled to receive the second reverse switching signal SW₂. The output of the second OR gate 244 is the output for the second set of logic and is a second rectifier control signal RECT_{P2} configured to bias gates of the second pair of rectifier switches N₂ and N₃. The input of the second set of logic is coupled to the second activation signal ACT₂, which is the output generated by the second direction detection comparator 224. The switching controller 218 can include a second rectifier diode D₄ having an anode coupled to the control terminal T_{CTRL} and a cathode coupled to the second rectifier terminal T_{R2}.

According to one example, the first power supply system operational state (e.g., normal operation mode) of the mode control signal EN can be a state where the power supply system 100 operates to provide the output voltage V_{OUT} based on the secondary current from the secondary winding L_{SEC1}, which is provided by the input voltage V_{IN} provided to the primary winding L_{PRI1}. In this way, the switching controller 218 is configured to activate the first and second pairs of rectifier switches (e.g., N₁ and N₄ as the first pair or N₂ and N₃ as the second pair) of the second switching stage 204 in response to the respective first and second directions of the secondary current I_{SEC} to generate the output voltage V_{OUT} in the first power supply system operational state (e.g., normal operation mode) of the mode control signal EN. Stated another way, the first and second sets of logic are configured to activate the first and second rectifier switches, respectively, to provide the secondary current to generate the output voltage V_{OUT} at the second switching stage 204 in response to the first state of the mode control signal EN.

A second power supply system operational state (e.g., reverse operation mode) of the mode control signal EN can be a state where the switching controller 218 is configured to activate the second pair of rectifier switches N₂ and N₃ in response to a first state of the second reverse switching signal SW₂. The activation of the second pair of rectifier switches N₂ and N₃ can provide a reverse primary current from the output voltage V_{OUT} in the first direction through the secondary winding L_{SEC1} to generate a reverse secondary current in the first direction through the primary winding L_{PRI1}. The reverse secondary current can thus correspond to reversal of the power of the power supply system 200, from the second switching stage 204 to a first switching stage (e.g., the first switching stage 202) in response to the second power supply system operational state (e.g., reverse operation mode) of the mode control signal EN. For example, the output voltage V_{OUT} can correspond to a battery voltage, such that the reverse operation mode is configured to provide power from the battery in the opposite direction of the power supply system 200. The switching controller 218 is configured to activate the second pair of rectifier switches N₂ and N₃ in response to a second state of each of the first and second reverse switching signals SW₁, SW₂ to provide the reverse primary current from the output voltage V_{OUT} in the second direction through the secondary winding L_{SEC1} to generate the reverse secondary current in the second direction through the primary winding L_{PRI1} to reverse the power flow in response to the second state (e.g., reverse operation mode) of the mode control signal EN.

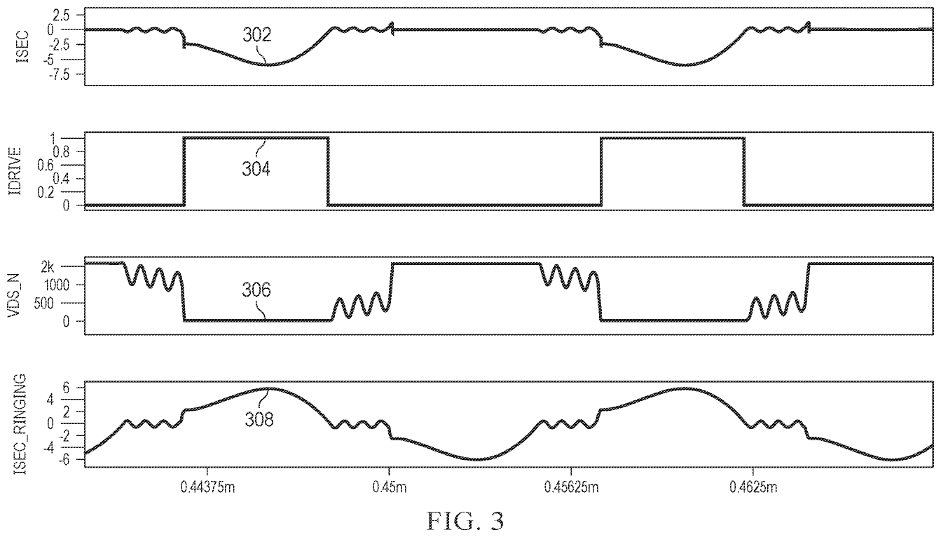

FIG. 3 is a timing diagram of waveforms associated with the power supply system 100. The third waveform 306 illustrates the voltage at gates of rectifier switches associated with the secondary current I_{SEC1}. Ringing in the voltage at gates of rectifier switches causes the secondary current (I_{SEC}, fourth waveform 308) for the power transformer 202 to artificially fluctuate in polarity or otherwise change direction in an undesirable manner. However, because the first reference voltage V_{REF} is tuned to be greater than voltages associated with any capacitive currents (e.g., thereby causing the first and second direction detection comparators 222, 224 to activate when changes occur above a threshold secondary current I_{SEC}), the drive signal for the synchronous rectifier (second waveform 304) is clean and unaffected by the ringing from the voltage at rectifier switches. In this way, the current (I_{SEC1} first waveform 302) can flow through the switch and not through the body diode.

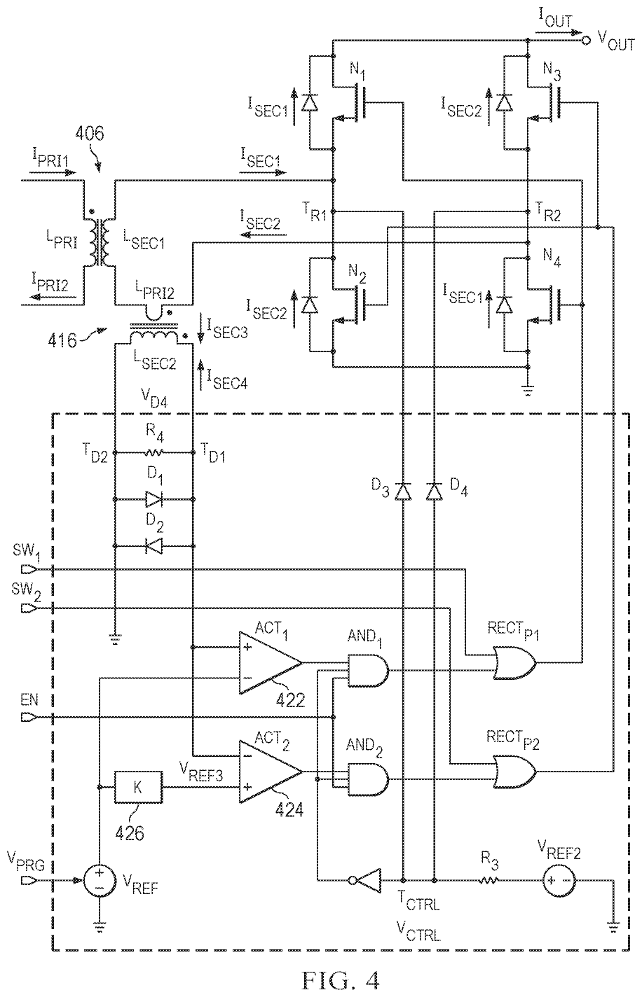

FIG. 4 is a schematic diagram of a power supply circuit, in an example. According to one example, FIG. 4 differs from FIG. 2 in that the power supply system 100 can be implemented with a single direction detection resistor R₄ (rather than two direction detection resistors) interconnecting the second detection terminal T_{D2s} and the first detection terminal T_{D1} and arranged in parallel with the first and second clamping diodes D₁, D₂.

The direction detection resistor R₄ can be configured to generate a first direction voltage V_{D4} in response to the first direction of the secondary current I_{SEC1} and a second direction voltage V_{D4} in response to the second direction of the secondary current I_{SEC2} in the secondary winding L_{SEC2} of the direction detection transformer 416 (and in the secondary winding L_{SEC1} of the power transformer 406). In this example, the polarity of the first direction voltage V_{D1} is utilized by the first and second direction detection comparators 422, 424 to determine the direction of the secondary current I_{SEC} in the secondary winding L_{SEC1} of the power transformer 406.

The first detection comparator 422 includes a first input, a second input, and an output. The first input of the first direction detection comparator 422 is coupled to the first detection terminal T_{D1} and the second input of the first direction detection comparator 422 is coupled to the first reference voltage V_{REF}, thereby enabling the first direction detection comparator 422 to compare the direction voltage VD₄ with the first reference voltage V_{REF}.

The second detection comparator 424 includes a first input, a second input, and an output. The polarity of the inputs of the second detection comparator 424 is switched relative to the first detection comparator 422. Thus, the second input of the first direction detection comparator 424 is coupled to the first detection terminal T_{D1} and the first input of the second direction detection comparator 424 is coupled to a step down 426, which steps down the first reference voltage V_{REF} to a third reference voltage V_{REF3}, thereby enabling the second direction detection comparator 424 to compare the direction voltage V_{D4} with the third reference voltage V_{REF3}.

Again, the reference voltage generator V_{REF} can be configured to generate the first reference voltage as a programmable variable reference voltage. In the example of FIG. 4, the first and second reference voltages can be approximately equal in magnitude but opposite in polarity.

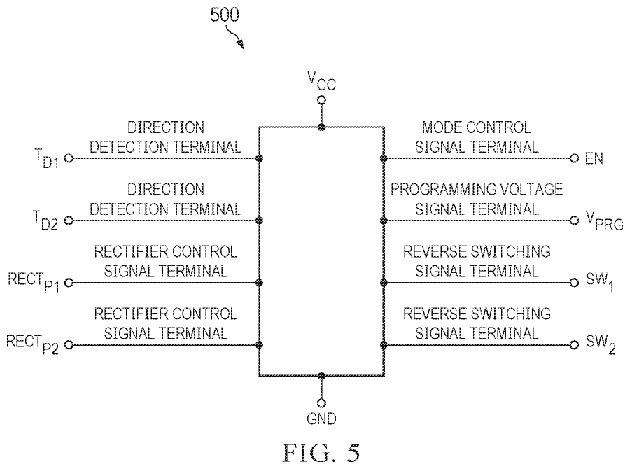

FIG. 5 is a diagram of an example of a power supply system integrated circuit (IC) 500. One or more components of the switching controller of FIG. 1, 2, or 4 and one or more components of the second switching stage can be implemented on the power supply system IC 500. For example, the power supply system IC 500 can include a power terminal, a ground terminal, the first direction detection terminal T_{D1}, the second direction detection terminal T_{D2}, a first rectifier control signal terminal, a second rectifier control signal terminal, a mode control signal terminal, a programming voltage signal terminal, a first reverse switching signal terminal, and a second reverse switching signal terminal. The power terminal can receive power V_{CC} and the ground terminal can be coupled to ground GND. The first and second direction detection terminals can be coupled to the direction detection transformer 116, which can be external to the power supply system IC 500. The first and second rectifier controller signal terminals can be coupled to gates of the rectifier switches (e.g., including switches N₁, N₂, N₃, N₄ as the first diagonal pair and the second diagonal pair described above) to provide the first and second rectifier control signals RECT_{P1}, RECT_{P2} to respective first and second diagonal pairs of rectifier switches.

The mode control signal terminal can be configured to receive the mode control signal EN to control or determine the operational state of the power supply system IC 500 (e.g., the first power supply system operational state as the normal operation mode or the second power supply system operational state as the reverse operation mode). The programming voltage signal terminal can be configured to receive the programming voltage signal V_{PRG} to program the reference voltage V_{REF}, for example. The first and second reverse switching signal terminals can be coupled to the first reverse switching signal SW₁ and the second reverse switching signal SW₂ to control operation in the second power supply system operational state or the reverse operation mode.

In this description, the term “couple” can cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

In this description, a device that is “configured to” perform a task or function can be configured (e.g., programmed and/or hardwired) at a time of manufacturing by a manufacturer to perform the function and/or can be configurable (or reconfigurable) by a user after manufacturing to perform the function and/or other additional or alternative functions. The configuring can be through firmware and/or software programming of the device, through a construction and/or layout of hardware components and interconnections of the device, or a combination thereof. Furthermore, a circuit or device that is described herein as including certain components can instead be configured to couple to those components to form the described circuitry or device. For example, a structure described herein as including one or more semiconductor elements (such as transistors), one or more passive elements (such as resistors, capacitors, and/or inductors), and/or one or more sources (such as voltage and/or current sources) can instead include only the semiconductor elements within a single physical device (e.g., a semiconductor die and/or integrated circuit (IC) package) and can be configured to couple to at least some of the passive elements and/or the sources to form the described structure, either at a time of manufacture or after a time of manufacture, such as by an end-user and/or a third-party.

The phrase “based on” means “based at least in part on”. Therefore, if X is based on Y, X can be a function of Y and any number of other factors.

Modifications are possible in the described embodiments, and other embodiments are possible, within the scope of the claims.

What is claimed is:

1. A switching controller, configured to:
activate a first rectifier switch of an output stage of a power supply system in a first state to provide a secondary current from a secondary winding of a first transformer to generate an output voltage at the output stage in response to detecting a first direction of a secondary current through a secondary winding of a second transformer; and
activate a second rectifier switch of the output stage of the power supply system in a second state to provide the secondary current from the secondary winding of the first transformer to generate the output voltage at the output stage in response to detecting a second direction of the secondary current through the secondary winding of the second transformer.

2. The switching controller of claim 1, comprising:
a first rectifier diode configured to activate the first rectifier switch in response to being forward-biased by the secondary current in the first direction; and
a second rectifier diode configured to activate the second rectifier switch in response to being forward-biased by the secondary current in the second direction.

3. The switching controller of claim 2, wherein each of the first and second rectifier diodes are coupled at an anode to a control terminal having a control voltage, wherein the control voltage is configured to be pulled to a logic-low in response to the first rectifier diode or the second rectifier diode being forward-biased to control activation of a respective one of the first rectifier switch or the second rectifier switch.

4. The switching controller of claim 1, wherein the secondary winding of the second transformer interconnects each of a first direction detection terminal and a second direction detection terminal that are each inputs of the switching controller to indicate one of the first direction and the second direction of the secondary current.

5. The switching controller of claim 4, wherein a turns ratio of the second transformer is greater than 50:1.

6. The switching controller of claim 4, comprising:
a first direction detection comparator configured to generate a first activation signal in response to a first direction voltage at the first direction detection terminal being greater than a first reference voltage, the first activation signal being provided to activate the first rectifier switch; and
a second direction detection comparator configured to generate a second activation signal in response to a second direction voltage at the second direction detection terminal being greater than a second reference voltage, the second activation signal being provided to activate the second rectifier switch.

7. The switching controller of claim 6, further comprising:
a first clamping diode configured to clamp the first direction voltage to a predefined amplitude; and
a second clamping diode configured to clamp the second direction voltage to the predefined amplitude.

8. The switching controller of claim 6, further comprising a resistor interconnecting the first and second direction detection terminals, the resistor being configured to generate the first direction voltage in response to the first direction of the secondary current and the second direction voltage in response to the second direction of the secondary current.

9. The switching controller of claim 6, further comprising:
a first resistor interconnecting the first direction detection terminal and a low-voltage rail, the first resistor being configured to generate the first direction voltage in response to the first direction of the secondary current; and
a second resistor interconnecting the second direction detection terminal and the low-voltage rail, the second resistor being configured to generate the second direction voltage in response to the second direction of the secondary current,
wherein the first and second reference voltages are approximately equal.

10. The switching controller of claim 6, further comprising a reference voltage generator configured to generate the first and second reference voltages as programmable variable reference voltages.

11. The switching controller of claim 6, further comprising:
a first set of logic comprising an input and an output, the input of the first set of logic being coupled to the first activation signal generated by the first direction detection comparator and the output of the first set of logic being coupled to an input of the first rectifier switch; and
a second set of logic comprising an input and an output, the input of the second set of logic being coupled to the second activation signal generated by the second direction detection comparator and the output of the second set of logic being coupled to an input of the second rectifier switch.

12. The switching controller of claim 11, wherein the first transformer comprises a primary winding configured to conduct a primary current from an input voltage to generate the secondary current, wherein the first set of logic is configured to receive a mode control signal and a first reverse switching signal, wherein the second set of logic is configured to receive the mode control signal and a second reverse switching signal,
wherein the first and second sets of logic are configured to activate the first and second rectifier switches, respectively, to provide the secondary current to generate the output voltage at the output stage in response to a first state of the mode control signal; and
wherein the first and second sets of logic are configured to activate the first and second rectifier switches, respectively, to provide a reverse primary current from the output voltage through the secondary winding of the first transformer to generate a reverse secondary current in the primary winding of the first transformer to reverse a flow of power, such that the switching controller provides power from the output voltage at the output stage, in response to a second state of the mode control signal and the respective first and second reverse switching signals.

13. A circuit comprising:
a resistor comprising a terminal coupled to a first current direction detection terminal;
a first direction detection comparator comprising a first input, a second input, and an output, the first input of the first direction detection comparator being coupled to the first current direction detection terminal and the second input of the first direction detection comparator being coupled to a first reference voltage;
a second direction detection comparator comprising a first input, a second input, and an output, the first input of the second direction detection comparator being coupled to a second current direction detection terminal and the second input of the second direction detection comparator being coupled to a second reference voltage;
a first set of logic comprising an input and an output, the input of the first set of logic being coupled to the output of the first direction detection comparator and the output of the first set of logic being coupled to an input of a first rectifier switch; and
a second set of logic comprising an input and an output, the input of the second set of logic being coupled to the output of the second direction detection comparator and the output of the second set of logic being coupled to an input of a second rectifier switch.

14. The circuit of claim 13, wherein the first set of logic comprises a first rectifier diode having an anode coupled to a control terminal and a cathode coupled to a first rectifier terminal; and wherein the second set of logic comprising a second rectifier diode having an anode coupled to the control terminal and a cathode coupled to a second rectifier terminal.

15. The circuit of claim 14, wherein the control terminal is coupled to a third reference voltage.

16. The circuit of claim 13, wherein the first set of logic comprises a first mode control AND gate comprising a first input, a second input, and an output, the first input of the first mode control AND gate being coupled to the output of the first direction detection comparator, the second input of the first mode control AND gate being coupled to receive a mode control signal; and wherein the second set of logic comprises a second mode control AND gate comprising a first input, a second input, and an output, the first input of the second mode control AND gate being coupled to the output of the second direction detection comparator, the second input of the second mode control AND gate being coupled to receive the mode control signal.

17. The circuit of claim 16, wherein the first set of logic further comprises a first OR gate comprising a first input, a second input, and an output, the first input of the first OR gate being coupled to the output of the first mode control AND gate, the second input of the first OR gate being coupled to receive a first reverse switching signal, the output of the first OR gate being coupled to an input of a first rectifier switch; and wherein the second set of logic comprises a second OR gate comprising a first input, a second input, and an output, the first input of the second OR gate being coupled to the output of the second mode control AND gate, the second input of the second OR gate being coupled to receive a second reverse switching signal, the output of the second OR gate being coupled to an input of a second rectifier switch.

18. A power supply system comprising:
a first switching stage configured to conduct a primary current in a first direction through a primary winding of a first transformer in a first state and in a second direction through the primary winding opposite the first direction in a second state to provide a secondary current in a first direction through a secondary winding of the first transformer in the first state and in a second direction through the secondary winding in the second state based on the primary current; and
a second switching stage configured to provide an output voltage at the second switching stage in response to the secondary current, the second switching stage comprising a switching controller, the switching controller being configured to:
activate a first rectifier switch of the second switching stage in a first state, the first rectifier switch configured to provide a secondary current from a secondary winding of the first transformer to generate an output voltage at the second switching stage in response to the switching controller detecting a first direction of a secondary current through a secondary winding of a second transformer; and
activate a second rectifier switch of the second switching stage in a second state, the second rectifier switch configured to provide the secondary current from the secondary winding of the first transformer to generate the output voltage at the second switching stage in response to the switching controller detecting a second direction of the secondary current through the secondary winding of the second transformer.

19. The power supply system of claim 18, wherein the switching controller comprises:
a first direction detection comparator configured to generate a first activation signal in response to a first direction voltage at a first direction detection terminal being greater than a first reference voltage, the first direction voltage being associated with the first direction of the secondary current, the first activation signal being provided to activate the first rectifier switch; and
a second direction detection comparator configured to generate a second activation signal in response to a second direction voltage at a second direction detection terminal being greater than a second reference voltage, the second direction voltage being associated with the second direction of the secondary current, the second activation signal being provided to activate the second rectifier switch.

20. The power supply system of claim 19, further comprising a resistor interconnecting the first and second direction detection terminals, the resistor being configured to generate the first direction voltage in response to the first direction of the secondary current and the second direction voltage in response to the second direction of the secondary current.

21. The power supply system of claim 19, further comprising:
a first resistor interconnecting the first direction detection terminal and a low-voltage rail, the first resistor being configured to generate the first direction voltage in response to the first direction of the secondary current; and
a second resistor interconnecting the second direction detection terminal and the low-voltage rail, the second resistor being configured to generate the second direction voltage in response to the second direction of the secondary current,
wherein the first and second reference voltages are approximately equal.

22. The power supply system of claim 18, wherein the switching controller comprises:
a first rectifier diode configured to activate the first rectifier switch in response to being forward-biased by the secondary current in the first direction; and
a second rectifier diode configured to activate the second rectifier switch in response to being forward-biased by the secondary current in the second direction.

23. The power supply system of claim 22, wherein each of the first and second rectifier diodes are coupled at an anode to a control terminal having a control voltage, wherein the control voltage is configured to be pulled to a logic-low in response to the first rectifier diode or the second rectifier diode being forward-biased to control activation of a respective one of the first rectifier switch or the second rectifier switch.

24. The power supply system of claim 18, wherein the switching controller is configured to receive a mode control signal, a first reverse switching signal, and a second reverse switching signal, wherein the switching controller is configured to activate the first and second rectifier switches of the second switching stage in response to the respective first and second directions of the secondary current to generate the output voltage in a first state of the mode control signal, the switching controller being further configured to:
activate the first rectifier switch in response to a first state of each of the first and second reverse switching signals to provide a reverse primary current from the output voltage in the first direction through the secondary winding of the first transformer to generate a reverse secondary current in the first direction through the primary winding of the first transformer to reverse a flow of power through the power supply system, such that the switching controller provides power from the output voltage at the second switching stage to the first switching stage in response to a second state of the mode control signal; and
activate the second rectifier switch in response to a second state of each of the first and second reverse switching signals to provide the reverse primary current from the output voltage in the second direction through the secondary winding of the first transformer to generate the reverse secondary current in the second direction through the primary winding of the first transformer to charge the power supply system associated with the first switching stage in response to the second state of the mode control signal.
